(19) United States
(12) Patent Application Publication
(10) Pub. No.: US 2019/0095143 A1
(43) Pub. Date: Mar. 28, 2019

(54) INTEGRATED CIRCUIT, IMAGE FORMING APPARATUS, AND ADDRESS ASSIGNMENT METHOD

(71) Applicants: KABUSHIKI KAISHA TOSHIBA, Tokyo (JP); TOSHIBA TEC KABUSHIKI KAISHA, Tokyo (JP)

(72) Inventor: Hidenori Kobayashi, Sunto Shizuoka (JP)

(21) Appl. No.: 15/713,878

(22) Filed: Sep. 25, 2017

(51) Int. Cl. G06F 3/12

(52) U.S. Cl. CPC G06F 3/126; G06F 3/1291; G06F 3/121

(57) ABSTRACT

In accordance with an embodiment, an integrated circuit comprises a plurality of general-purpose terminals, a first register, a second register and an assignment section. The first register stores a value indicating a state of the general-purpose terminal. The second register stores a value of a register indicated by an address based on the assigned address. The assignment section configured to assign addresses of at least a part of the first registers among the first registers as addresses to be stored in the second register adjacently to a predetermined address in the second register and addresses subsequent to the predetermined address based on connection with the general-purpose terminal.

### FIELD

Embodiments described herein relate generally to an integrated circuit, an image forming apparatus, and an address assignment method.

### BACKGROUND

In an image processing apparatus such as a digital multifunction peripheral, in order to reduce manufacturing costs, in many cases, a common substrate is adopted for different models. As a result of standardizing the substrate, a common designed involves not using a part of the hardware of a substrate in a low end model or an apparatus main body that does not have an optional device. In such a case, the hardware cannot be fully utilized.

### BRIEF DESCRIPTION OF THE DRAWINGS

FIG. 1 is an external constitution diagram illustrating an example of an image forming system according to an embodiment;

FIG. 2 is a functional constitution diagram illustrating an example of the constitution of an image forming apparatus according to the present embodiment;

FIG. 3 is a diagram illustrating an example of correspondence between a register of an ASIC and an address according to the present embodiment;

FIG. 4 is a second diagram illustrating an example of information transmitted and received in accordance with a command executed by a CPU according to the present embodiment;

FIG. 5 is a second diagram illustrating an example of information transmitted and received in accordance with a command executed by the CPU according to the present embodiment;

FIG. 6 is a first diagram illustrating an example of an initial setting of a general-purpose terminal according to the present embodiment;

FIG. 7 is a second diagram illustrating an example of the initial setting of the general-purpose terminal according to the present embodiment;

FIG. 8 is a third diagram illustrating an example of the initial setting of the general-purpose terminal according to the present embodiment;

FIG. 9 is a diagram illustrating an example of a processing for detecting presence or absence of failure in an optional device of the CPU;

FIG. 10 is a diagram illustrating an example of correspondence between an assignment register of the ASIC and an address according to the present embodiment;

FIG. 11 is a diagram illustrating an example of an initial setting of an assignment setting register according to the present embodiment;

FIG. 12 is a diagram illustrating an example of reading information of the assignment register according to the present embodiment; and

FIG. 13 is a flowchart illustrating an example of the operation of the image forming apparatus according to the present embodiment.

### DETAILED DESCRIPTION

In accordance with an embodiment, an integrated circuit comprises a plurality of general-purpose terminals, a first register, a second register and an assignment section. The first register stores a value input to the general-purpose terminal or a value output by the general-purpose terminal. The second register stores a value of a register indicated by an address based on the first register and the assigned address. The assignment section assigns addresses of at least a part of the first registers among the first registers as addresses to be stored in the second register adjacently to a predetermined address in the second register and addresses subsequent to the predetermined address based on connection with the general-purpose terminal.

Hereinafter, an integrated circuit of an embodiment is described with reference to the accompanying drawings.

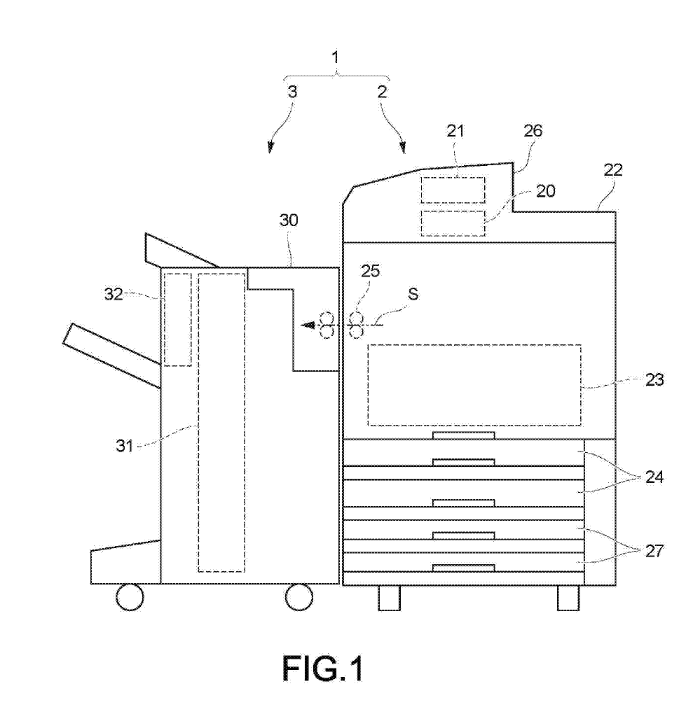

FIG. 1 is an external constitution diagram illustrating an example of an image forming system 1 according to the embodiment. In the present embodiment, the image forming system 1 includes an image forming apparatus 2 and a post-processing apparatus 3. The image forming apparatus 2 forms an image on a sheet-like image receiving medium (hereinafter, referred to as a “sheet S”) such as a paper. For example, the image forming apparatus 2 is an MFP (Multi-Function Peripherals), a printer, a copying machine, and the like. The post-processing apparatus 3 executes a post-processing on the sheet S conveyed from the image forming apparatus 2. The sheet S includes not only the paper but also a plastic sheet such as an OHP (overhead projector) sheet.

The image forming apparatus 2 includes a controller 20, a control panel 21, a scanner section 22, a printing section 23, a sheet feed section 24, a sheet discharge section 25, a two-sided document scanning device 26 and a high-capacity sheet feed device 27.

The control panel 21 includes various keys or a touch panel for receiving an operation by a user. The control panel 21 receives, for example, an input relating to a type of the post-processing on the sheet S. The image forming apparatus sends to the post-processing apparatus 3 information (hereinafter, referred to as post-processing information) on the type of the post-processing input by the control panel 21.

The scanner section 22 includes a reading section which reads image information of an object to be copied. The scanner section 22 sends the read image information to the printing section 23.

Based on image information transmitted from the scanner section 22 or an external device, the printing section 23 forms an output image (hereinafter, referred to as a toner image) with a developer such as a toner. The printing section 23 transfers the toner image onto a surface of the sheet S. The printing section 23 fixes the toner image on the sheet S by applying heat and pressure to the toner image transferred onto the sheet S.

The sheet feed section 24 supplies the sheets S one by one to the printing section 23 in accordance with a timing at which the printing section 23 forms the toner image.

The sheet discharge section 25 conveys the sheet S discharged from the printing section 23 to the post-processing apparatus 3.

The two-sided document scanning device 26 includes a reading section which reads image information of an object to be copied simultaneously on both sides of the object to be copied. The two-sided document scanning device 26 sends the read image information to the printing section 23.

The high-capacity sheet feed device 27 is capable of storing more sheets S than the sheet feed section 24. The high-capacity sheet feed device 27 supplies the sheets S one by one to the printing section 23 in accordance with the timing at which the printing section 23 forms the toner image.

The controller 20 controls the overall operation of the image forming apparatus 2. The controller 20 controls the control panel 21, the scanner section 22, the printing section 23, the sheet feed section 24, the sheet discharge section 25, the two-sided document scanning device 26 and the high-capacity sheet feed device 27. The controller 20 is formed by a control circuit including a CPU (Central Processing Unit), a ROM (Read Only Memory), and a RAM (Random Access Memory). A processing by the controller 20 is described in detail later.

Next, the post-processing apparatus 3 is described.

For example, the post-processing apparatus 3 is arranged adjacent to the image forming apparatus 2. The sheet S is conveyed from the image forming apparatus 2 to the post-processing apparatus 3. The post-processing apparatus 3 executes the post-processing on the conveyed sheet S. In the present embodiment, the post-processing apparatus 3 includes a relay unit 30, a staple finisher 31, and a hole punching finisher 32.

The staple finisher 31 executes a stapling processing on the conveyed sheet S. The stapling processing is used for binding the sheet S with a stapler. In the stapling processing, for example, the sheets S may be stapled by a metal needle stapler, or the sheets S may be temporarily fixed to each other by processing the sheets into a tooth shape by pressure.

The hole punching finisher 32 executes a hole punching processing on the conveyed sheet S. The hole punching processing is a processing of drilling a hole at a predetermined position of the sheet S. In the hole punching processing, for example, two holes are drilled at predetermined positions of the sheet S.

The relay unit 30 conveys the sheet S discharged from the image forming apparatus 2 to each section of the post-processing apparatus 3. The relay unit 30 conveys the sheet S to each section of the post-processing apparatus 3 based on information (hereinafter, referred to as post-processing information) indicating the post-processing executed on the sheet S. Specifically, the relay unit 30 conveys the sheet S to the staple finisher 31 if the post-processing information indicates that the stapling processing is executed. The relay unit 30 conveys the sheet S to the hole punching finisher 32 if the post-processing information indicates that the hole punching processing is executed.

The constitution of the image forming apparatus 2 is described in detail below with reference to the drawings.

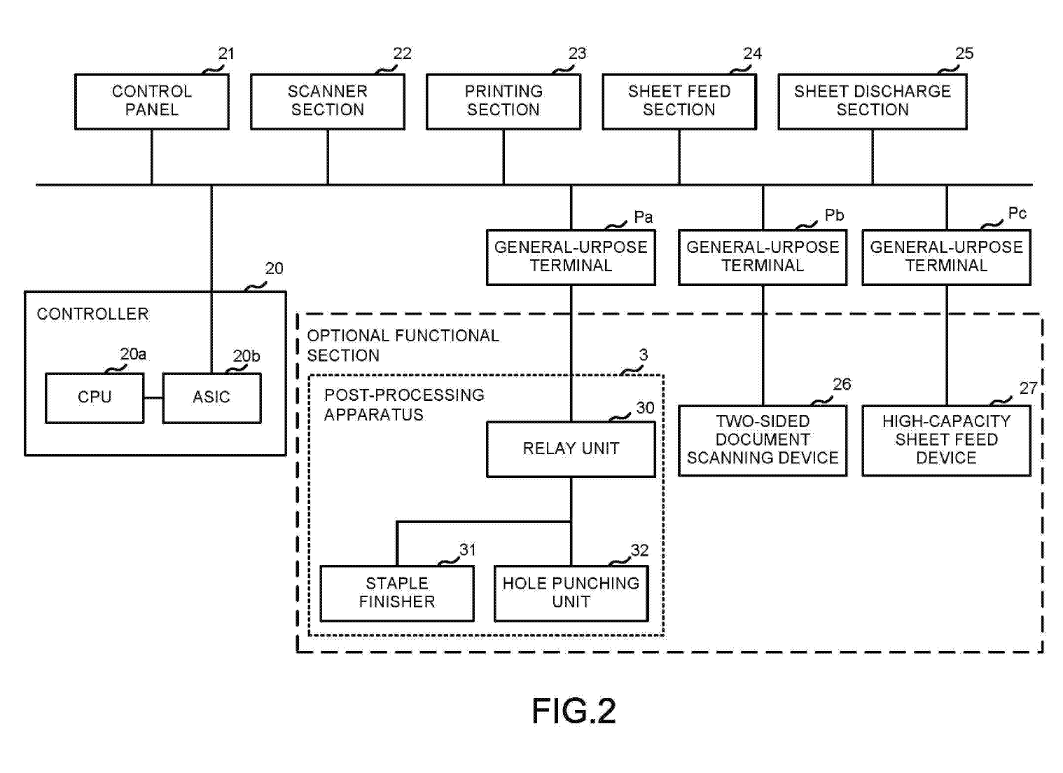

FIG. 2 is a functional constitution diagram illustrating an example of the constitution of the image forming apparatus 2 according to the present embodiment.

The controller 20 executes a program stored in a storage section (not shown) of the image forming apparatus 2 to realize each functional section. The functional section may be realized by hardware such as an LSI (Large Scale Integration), an ASIC (Application Specific Integrated Circuit), an FPGA (Field-Programmable Gate Array), and the like, or may be realized by cooperation of the software and the hardware.

In the present embodiment, the function of the controller 20 is realized by cooperation of a CPU (hereinafter, referred to as a CPU 20a) and the ASIC (hereinafter, referred to as an ASIC 20b). Each section of the image forming apparatus 2 is connected to the ASIC 20b. The ASIC 20b operates under the control of the CPU 20a. The CPU 20a controls each section connected to the ASIC 20b based on the state of the ASIC 20b. In the present embodiment, the CPU 20a and the ASIC 20b transmit and receive information by serial communication. The controller 20 is an example of an integrated circuit.

Furthermore, the ASIC 20b includes a plurality of general-purpose terminals P. In an example of the present embodiment, the ASIC 20b includes a general-purpose terminal Pa, a general-purpose terminal Pb and a general-purpose terminal Pc. In the following description, the general-purpose terminal Pa, the general-purpose terminal Pb and the general-purpose terminal Pc are collectively referred to as a general-purpose terminal P if they are not distinguished. If the image forming apparatus 2 includes an optional device, the optional device is connected to the general-purpose terminal P. In the present embodiment, if the image forming apparatus 2 is a low end model, the image forming apparatus 2 includes the control panel 21, the scanner section 22, the printing section 23, the sheet feed section 24 and the sheet discharge section 25. In other words, the optional devices of the image forming apparatus 2 are, for example, the two-sided document scanning device 26, the high-capacity sheet feed device 27 and the post-processing apparatus 3. In the present embodiment, the post-processing apparatus 3 is connected to the general-purpose terminal Pa. The two-sided document scanning device 26 is connected to the general-purpose terminal Pb. The high-capacity sheet feed device 27 is connected to the general-purpose terminal Pc.

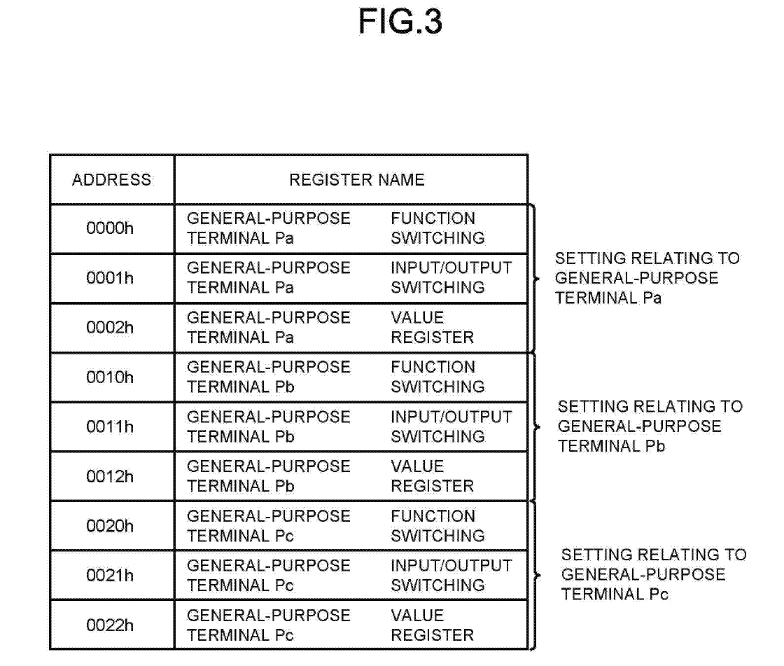

Hereinafter, the correspondence between the register of the ASIC 20b and the address is described with reference to FIG. 3.

FIG. 3 is a diagram illustrating an example of correspondence between the register of the ASIC 20b and the address according to the present embodiment. For each of the general-purpose terminals P, the ASIC 20b has the register storing information on the general-purpose terminal P. For example, the ASIC 20b has registers having addresses “0000h”, “0001h” and “0002h” for storing the information on the general-purpose terminal Pa. For example, the ASIC 20b includes registers having addresses “0010h”, “0011h” and “0012h” for storing the information on the general-purpose terminal Pb. For example, the ASIC 20b includes registers having addresses “0020h”, “0021h” and “0022h” for storing the information on the general-purpose terminal Pc.

In the registers having the addresses “0000h”, “0010h” and “0020h”, information indicating setting to enable or disable the function of the general-purpose terminal P is stored. In the following description, a register storing the information indicating setting to enable or disable the function of the general-purpose terminal P is described as a function switching register.

In the registers having the addresses “0001h”, “0011h”, and “0021h”, information indicating setting relating to a use method of the general-purpose terminal P is stored. The information indicating the setting relating to the use method indicates, for example, whether the general-purpose terminal P is used as an input terminal or an output terminal. In the following description, a register storing the information indicating the setting relating to the use method of the general-purpose terminal P is described as an input/output switching register.

Information indicating a state of the general-purpose terminal P is stored in the registers having the addresses “0002h”, “0012h” and “0022h”. The information indicating the state of the general-purpose terminal P indicates, for example, a state of the optional device connected to the general-purpose terminal P. Specifically, the information indicating the state of the general-purpose terminal P indicates presence or absence of a malfunction of the optional device connected to the general-purpose terminal P. In the following description, the register storing the information (value) indicating the state of the general-purpose terminal P is described as a value register. The value register is an example of a first register.

Hereinafter, with reference to the drawings, information transmitted and received between the CPU 20a and the ASIC 20b in accordance with a command executed by the CPU 20a is described.

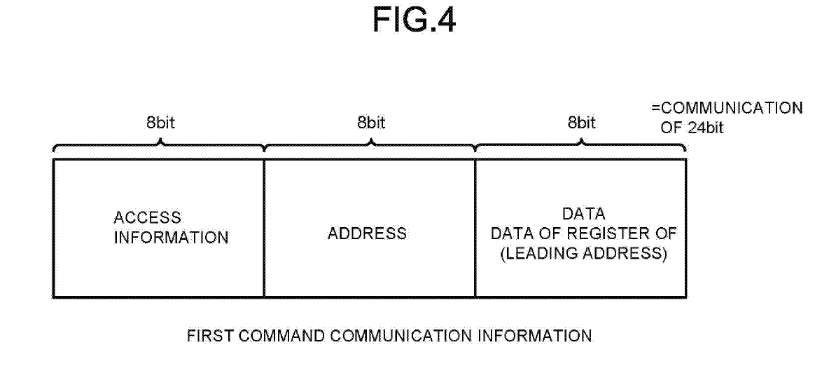

FIG. 4 is a second diagram illustrating an example of the information transmitted and received in accordance with the command executed by the CPU 20a according to the present embodiment.

The CPU 20a executes various commands and accesses the register of the ASIC 20b. Along with this, information on the access is transmitted and received between the CPU 20a and the ASIC 20b. The command executed by the CPU 20a is, for example, a command (hereinafter, “write” command) for writing information in the register which is an access object. The command executed by the CPU 20a is, for example, a command (“read” command) for reading information from the register which is the access object. Hereinafter, the information transmitted and received as the CPU 20a executes the command and accesses the register which is the access object is described as a first command communication information. The first command communication information is transmitted and received between the CPU 20a and the ASIC 20b.

As shown in FIG. 4, the first command communication information includes access information, information indicating the address, and data in the order of recording. The access information indicates whether the command executed by the CPU 20a is the “write” command or the “read” command. For example, the information indicating the address indicates the address of the register which is the access object of the command indicated by the access information. The data is information on the register which is the access object. More specifically, if the access information indicates the “write” command, the data is written to the register which is the access object. In addition, if the access information indicates the “read” command, the data is stored in the register which is the access object.

In the present embodiment, the access information, the address, and the data all have 8-bit size. Therefore, the first command communication information has 24-bit length.

The CPU 20a may access a plurality of the registers by one command. Hereinafter, a case in which the CPU 20a executes various commands and accesses the plural registers of the ASIC 20b is described with reference to the drawings.

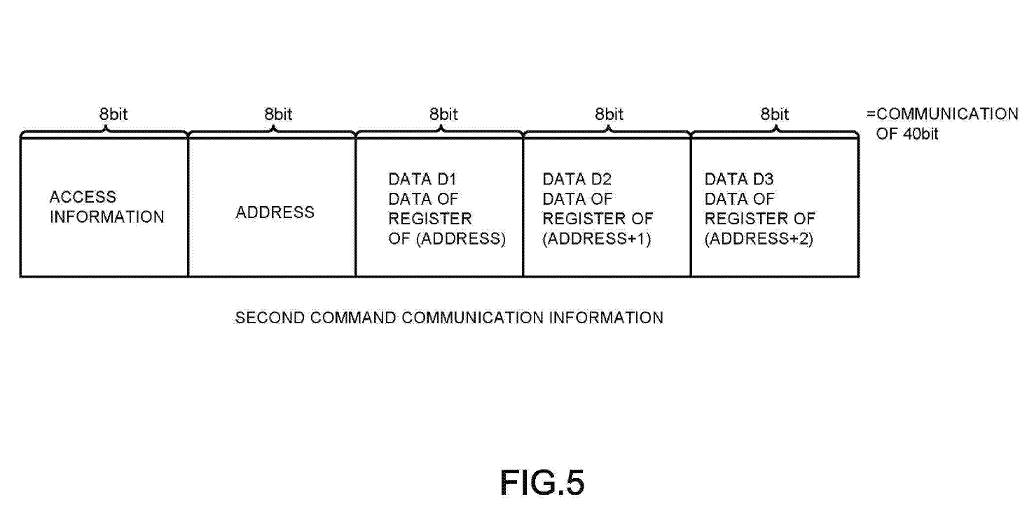

FIG. 5 is a second diagram illustrating an example of information transmitted and received in accordance with the command executed by the CPU 20a according to the present embodiment.

The CPU 20a executes various commands and accesses the plural registers of the ASIC 20b. Along with this, information on the accesses is transmitted and received between the CPU 20a and the ASIC 20b. Hereinafter, the information transmitted and received as the CPU 20a executes the commands and accesses the plurality of the registers which are access objects is described as a second command communication information. The second command communication information is transmitted and received between the CPU 20a and the ASIC 20b.

The second command communication information includes access information, information indicating the address, and a plurality of data in the order of recording. Hereinafter, a case in which three data (data D1 to data D3) are included in the second command communication information is described. The data D1 relates to the register designated by the address. The data D2 relates to the register adjacent to the register designated by the address. The register is designated by an address obtained by adding “1” to the address included in the second command communication information. The data D3 relates to the register adjacent to the register of the data D2. The register is designated by an address obtained by adding “2” to the address included in the second command communication information.

Therefore, if the access information in the second command communication information indicates the “write” command, the data D1 is written to the register designated by the address. The data D2 is written to the register designated by the address obtained by adding “1” to the address included in the second command communication information. The data D3 is written to the register designated by the address obtained by adding “2” to the address included in the second command communication information.

In addition, if the access information in the second command communication information indicates the “read” command, the data D1 is stored in the register designated by the address. The data D2 is stored in the register designated by the address obtained by adding “1” to the address included in the second command communication information. The data D3 is stored in the register designated by the address obtained by adding “2” to the address included in the second command communication information.

If the second command communication information includes three data D, the second command communication information has 40-bit length.

The ASIC 20b detects a connection state of the optional device connected to the general-purpose terminal P of the ASIC 20b in an initial state such as at the time the image forming apparatus 2 is started. For example, the ASIC 20b detects the connection state of the optional device based on a voltage level of the general-purpose terminal P in the initial state of the image forming apparatus 2.

Based on the connection state of the optional device detected by the ASIC 20b, the CPU 20a executes the initial setting of each general-purpose terminal P. Specifically, if an optional device is connected to the general-purpose terminal P, the CPU 20a executes the initial setting of the general-purpose terminal P. As described above, in the present embodiment, optional devices are respectively connected to the general-purpose terminal Pa, the general-purpose terminal Pb and the general-purpose terminal Pc.

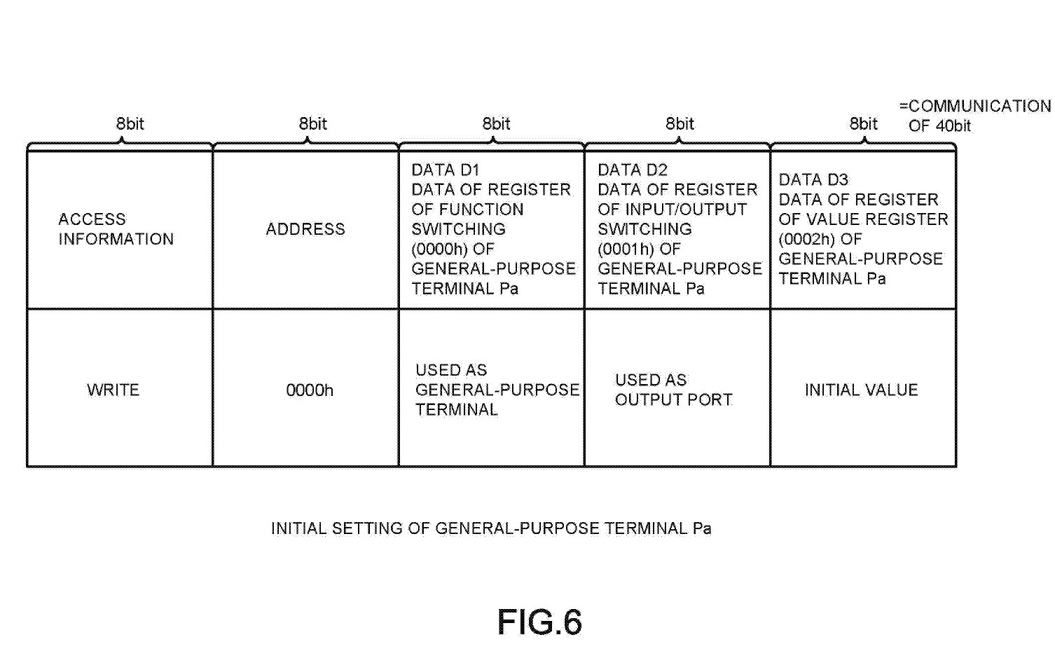

The details of the initial setting of the general-purpose terminal Pa, the general-purpose terminal Pb and the general-purpose terminal Pc executed by the CPU 20a are described below with reference to FIG. 6 to FIG. 8.

FIG. 6 is a first diagram illustrating an example of the initial setting of the general-purpose terminal Pa according to the present embodiment.

As mentioned above, the registers storing the information on the general-purpose terminal Pa are those having addresses “0000h”, “0001h” and “0002h”. The registers storing the information on the general-purpose terminal Pa are the registers having the adjacent addresses subsequent to the address “0000h” . The CPU 20a executes the “write” command and executes the initial setting relating to the general-purpose terminal Pa. Specifically, the CPU 20a executes the “write” command to the registers having the addresses “0000h”, “0001h” and “0002h”.

For example, the CPU 20a writes the information indicating that the function of the general-purpose terminal Pa is enabled to the register having the address “0000h” . As a result, the function of the general-purpose terminal Pa is enabled. The CPU 20a writes the information indicating that the general-purpose terminal Pa is used as an output terminal for the register having the address “0001h”, for example. Thus, the general-purpose terminal Pa is used as the output terminal. Herein, the post-processing apparatus 3 operates under the control of the image forming apparatus 2 (the controller 20) . By using the general-purpose terminal Pa as the output terminal, the controller 20 can output information on the control to the post-processing apparatus 3. The CPU 20a writes an initial value to the register having the address “0002h”. The initial value is predetermined so that the operation of the post-processing apparatus 3 does not become indefinite in the initial state.

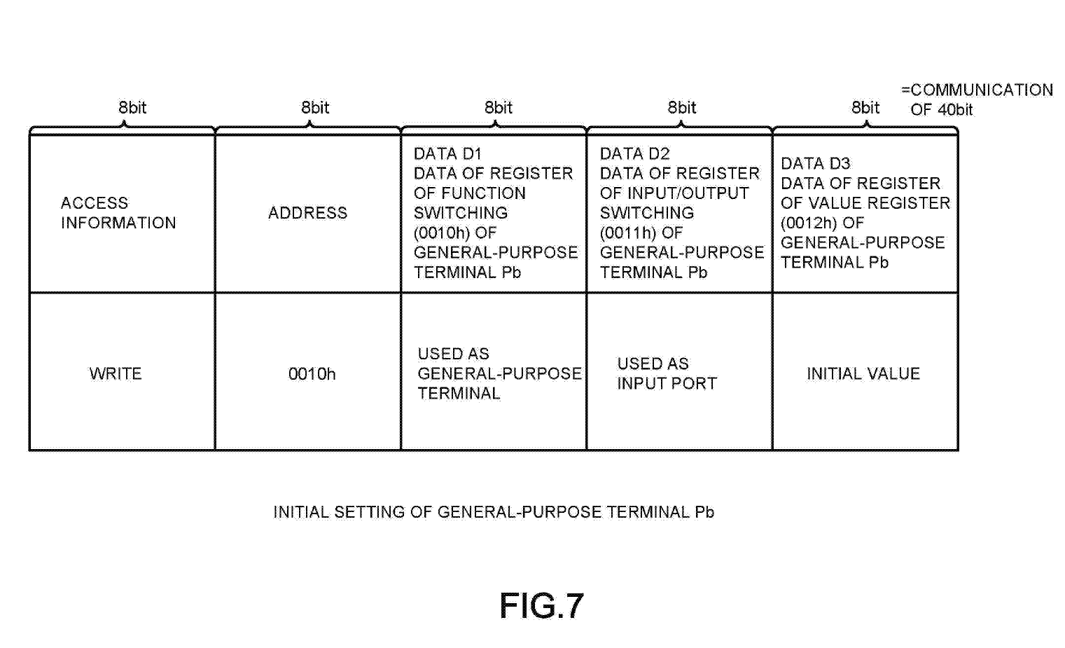

FIG. 7 is a second diagram illustrating an example of the initial setting of the general-purpose terminal Pb according to the present embodiment.

As mentioned above, the registers storing the information on the general-purpose terminal Pb are the registers having the addresses “0010h”, “0011h” and “0012h”. The registers storing information on the general-purpose terminal Pb are the registers having the adjacent addresses subsequent to the address “0010h”. The CPU 20a executes the “write” command and executes the initial setting on the general-purpose terminal Pb. Specifically, the CPU 20a executes the “write” command on the registers having the addresses “0010h”, “0011h”, and “0012h”.

For example, the CPU 20a writes information indicating that the function of the general-purpose terminal Pb is enabled to the register having the address “0010h”. As a result, the function of the general-purpose terminal Pb is enabled. For example, the CPU 20a writes the information indicating that the general-purpose terminal Pb is used as an input terminal to the register having the address “0011h”. Thus, the general-purpose terminal Pb is used as the input terminal. Herein, the two-sided document scanning device 26 sends the read image information to the printing section 23. By using the general-purpose terminal Pb as the input terminal, the two-sided document scanning device 26 can send the read image information to the printing section 23. The CPU 20a writes an initial value to the register having the address “0012h”. The initial value is predetermined so that the operation of the two-sided document scanning device 26 does not become indefinite in the initial state.

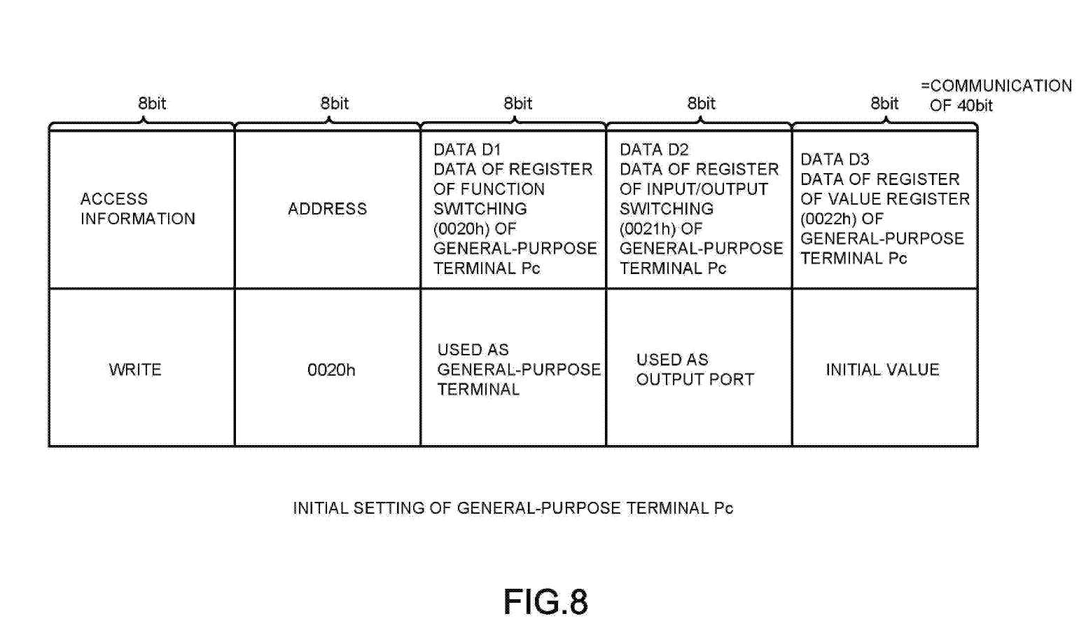

FIG. 8 is a third diagram illustrating an example of the initial setting of the general-purpose terminal Pc according to the present embodiment.

As mentioned above, the registers storing the information on the general-purpose terminal Pc are the registers having the addresses “0020h”, “0021h” and “0022h”. The registers storing the information on the general-purpose terminal Pc are the registers having the adjacent addresses subsequent to the address “0020h”. The CPU 20a executes the “write” command and executes the initial setting on the general-purpose terminal Pc. Specifically, the CPU 20a executes the “write” command to the registers having the addresses “0020h”, “0021h” and “0022h”.

For example, the CPU 20a writes the information indicating that the function of the general-purpose terminal Pc is enabled to the register having the address “0020h”. As a result, the function of the general-purpose terminal Pc is enabled. For example, the CPU 20a writes the information indicating that the general-purpose terminal Pc is used as an output terminal to the register having the address “0021h”. As a result, the general-purpose terminal Pc is used as the output terminal. Herein, the high-capacity sheet feed device 27 operates under the control of the image forming apparatus 2 (the controller 20). By using the general-purpose terminal Pc as the output terminal, the controller 20 can output the information on the control to the high-capacity sheet feed device 27. The CPU 20a writes an initial value to the register having the address “0022h”. The initial value is predetermined so that the operation of the high-capacity sheet feed device 27 does not become indefinite in the initial state.

As described above, the CPU 20a initially sets each general-purpose terminal P so that each general-purpose terminal P operates, and the ASIC 20b and the optional device are connected to be capable of transmitting and receiving the information.

The CPU 20a detects the state of the optional device at predetermined time intervals. Specifically, the CPU 20a reads the data stored in the register indicating the state of the general-purpose terminal P at predetermined time intervals. Based on the read data, the CPU 20a detects the presence or absence of the malfunction of the optional device connected to the general-purpose terminal P.

Hereinafter, with reference to the drawings, details of the processing in which the CPU 20a detects the presence or absence of the malfunction of the optional device are described.

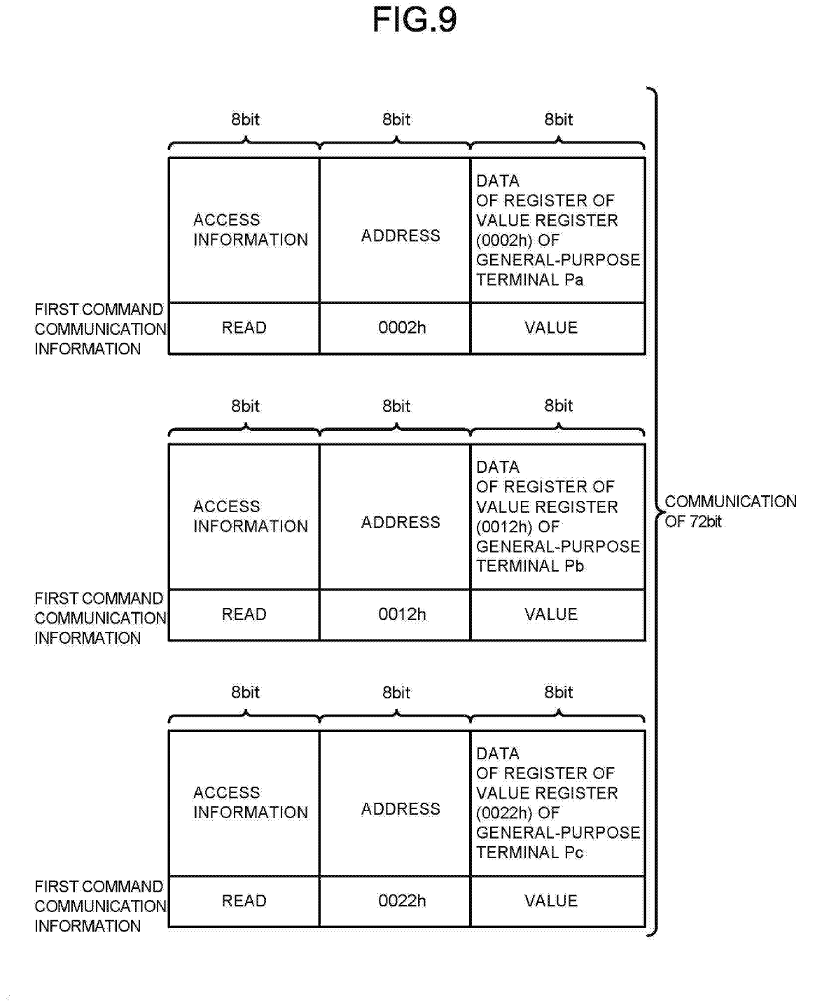

FIG. 9 is a diagram illustrating an example of a processing for detecting presence or absence of failure of the optional device by the CPU 20a. As described above, in the ASIC 20b of the present embodiment, the addresses of the value registers of the general-purpose terminals P are not adjacent. Therefore, in a case of reading the information from the value register of each general-purpose terminal P, the CPU 20a reads the value register of each general-purpose terminal P by the first command communication information. As shown in FIG. 9, in a case of reading the information from the value register of each general-purpose terminal P, the CPU 20a receives the first command communication information three times from the ASIC 20b. Therefore, as the CPU 20a reads the information of the value register of each general-purpose terminal P, 72-bit information is communicated between the CPU 20a and the ASIC 20b.

Herein, various information is communicated between the CPU 20a and the ASIC 20b in addition to the information indicating the state of the optional device at predetermined time intervals. Therefore, the information between the CPU 20a and the ASIC 20b is preferably executed in a short processing time. In other words, it is preferable that the CPU 20a acquires the information indicating the state of the optional device by communication with a small amount of the information.

Hereinafter, with reference to the drawings, a constitution is described in which the CPU 20a of the present embodiment acquires the information indicating the state of the optional device by communication with a small amount of the information.

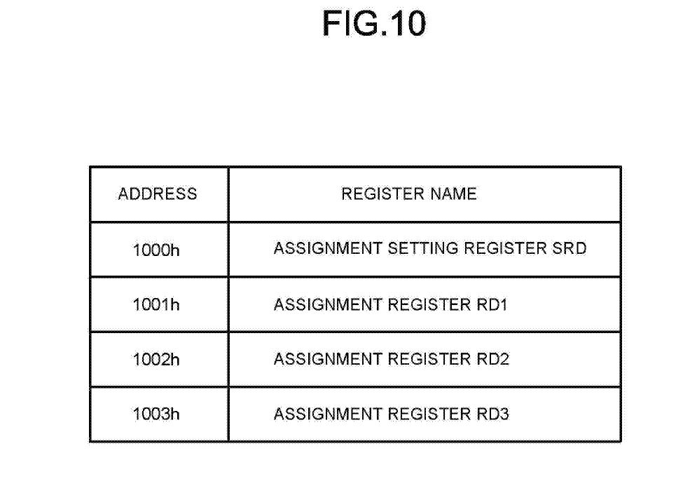

FIG. 10 is a diagram illustrating an example of correspondence between an assignment register of the ASIC 20b and the address according to the present embodiment. The ASIC 20b of the present embodiment includes a plurality of the assignment registers (hereinafter, referred to as assignment registers RD). The assignment register RD stores a value of the register corresponding to the address assigned to the assignment register RD. In the assignment register RD, the address of the register assigned to the assignment register RD is set in the register (hereinafter, referred to as an assignment setting register SRD) having the address “1000h”. Specifically, setting information is stored in the assignment setting register SRD. The setting information indicates the address of the register assigned to the assignment register RD. The assignment registers RD1 to RD3 store the values of the registers having the addresses indicated by the setting information stored in the assignment setting register SRD.

The address of the assignment register RD1 is “1001h”. The address of the assignment register RD2 is “1002h”. The address of the assignment register RD3 is “1003h”. Herein, the assignment register RD1 has an address with higher order than the assignment register RD2. The assignment register RD2 has an address with higher order than the assignment register RD3. The assignment register RD3 has an address with lower order than the assignment register RD2. The assignment register RD2 has the address with lower order than the assignment register RD1. The assignment register RD is an example of a second register. The assignment setting register SRD is an example of an assignment section.

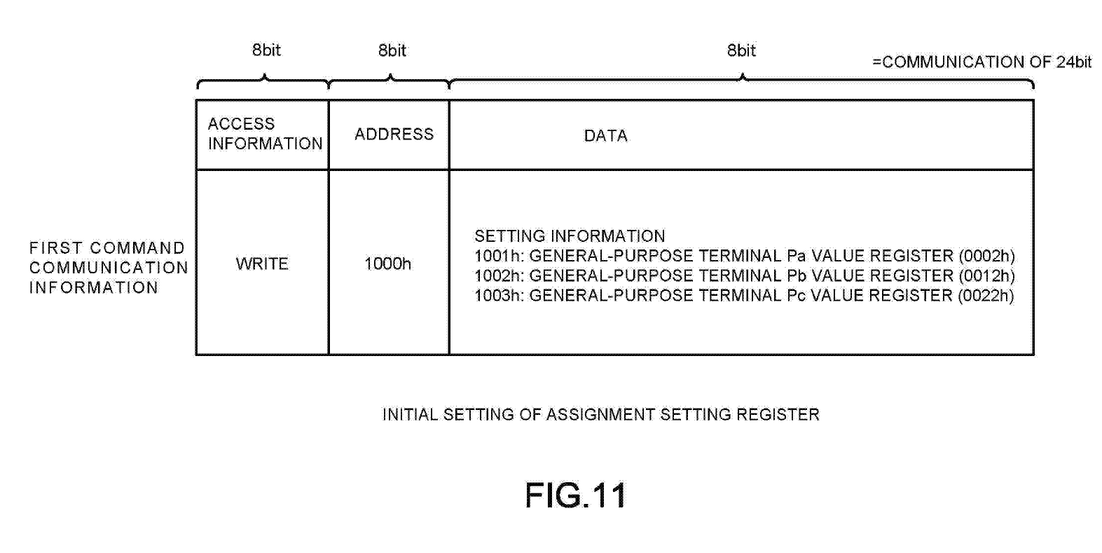

FIG. 11 is a diagram illustrating an example of an initial setting of the assignment setting register SRD according to the present embodiment.

The CPU 20a of the present embodiment executes the initial setting of the assignment register RD based on the connection state of the optional device detected by the ASIC 20b. More specifically, if the optional device is connected to the general-purpose terminal P, the CPU 20a assigns the value register of the general-purpose terminal P to the assignment register RD. More specifically, the CPU 20a writes to the assignment setting register SRD the setting information indicating the address of the value register of the general-purpose terminal P to which the optional device is connected.

As described above, in the present embodiment, the optional devices are respectively connected to the general-purpose terminal Pa, the general-purpose terminal Pb and the general-purpose terminal Pc. Therefore, the CPU 20a of the present embodiment writes the setting information indicating the addresses of the value registers of the general-purpose terminal Pa, the general-purpose terminal Pb and the general-purpose terminal Pc to the assignment setting register SRD.

As the setting information is written to the assignment setting register SRD, the assignment register RD1 to the assignment register RD3 store the information of the registers assigned to the assignment registers. Specifically, the assignment register RD1 stores the information stored in the value register of the general-purpose terminal Pa. In other words, the assignment register RD1 mirrors the information stored in the value register of the general-purpose terminal Pa. The assignment register RD2 stores the information stored in the value register of the general-purpose terminal Pb. In other words, the assignment register RD2 mirrors the information stored in the value register of the general-purpose terminal Pb. The assignment register RD3 stores the information stored in the value register of the general-purpose terminal Pc. In other words, the assignment register RD3 mirrors the information stored in the value register of the general-purpose terminal Pc.

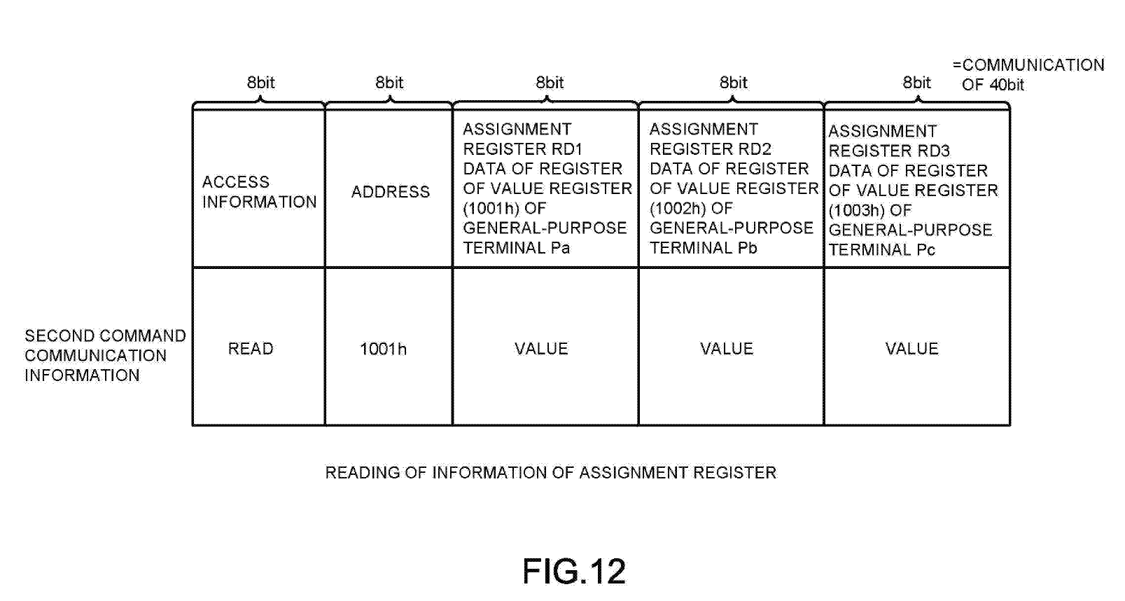

The CPU 20a refers to the information stored in each assignment register RD and indirectly refers to the information stored in the register assigned to the assignment register RD. Hereinafter, with reference to FIG. 12, the details of the command in which the CPU 20a refers to the assignment register RD are described.

FIG. 12 is a diagram illustrating an example of reading the information of the assignment register RD according to the present embodiment.

As described above, the assignment registers RD1 to RD3 are the registers having the addresses “1001h”, “1002h” and “1003h”. The assignment registers RD1 to RD3 have adjacent addresses. As the CPU 20a executes the “read” command, the CPU 20a reads values stored in the assignment registers RD1 to RD3 by the second command communication information. The CPU 20a reads the value stored in the assignment register RD1 to refer to it. As a result, the CPU 20a indirectly refers to the value stored in the value register of the general-purpose terminal Pa. The CPU 20a reads the value stored in the assignment register RD2 to refer to it. As a result, the CPU 20a indirectly refers to the value stored in the value register of the general-purpose terminal Pb. The CPU 20a reads the value stored in the assignment register RD3 to refer to it. As a result, the CPU 20a indirectly refers to the value stored in the value register of the general-purpose terminal Pc.

Herein, if the CPU 20a reads the information of the value register of each general-purpose terminal P, 72-bit information is communicated between the CPU 20a and the ASIC 20b (refer to FIG. 9). On the other hand, the CPU 20a reads the information of the assignment register RD to indirectly read the information of the value register of each general-purpose terminal P (refer to FIG. 12) in some cases. In this case, the CPU 20a can acquire the information of the value register of each general-purpose terminal P by communication with a small amount of information which is 40-bit information.

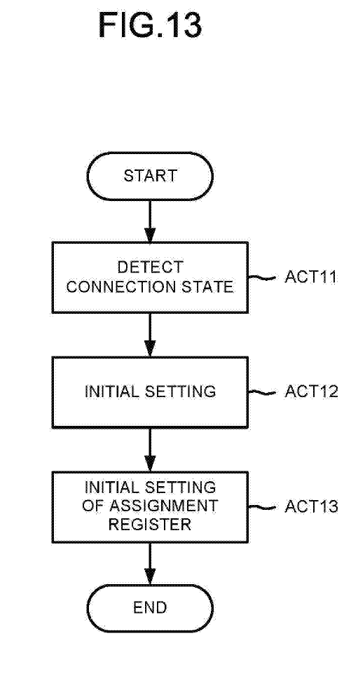

The operation of the image forming apparatus 2 is described in detail with reference to FIG. 13. FIG. 13 is a flowchart illustrating an example of the operation of the image forming apparatus 2 according to the present embodiment. In the initial state of the image forming apparatus 2, the ASIC 20b detects the connection state of the general-purpose terminal P (ACT 11). The CPU 20a executes the initial setting of each general-purpose terminal P (ACT 12). The CPU 20a executes the initial setting of the assignment register RD based on the connection state of the general-purpose terminal P detected by the ASIC 20b (ACT 13). Specifically, the CPU 20a generates setting information for assigning to the assignment register RD the register indicating the state of the general-purpose terminal P to which the optional device is connected. The CPU 20a writes the generated setting information to the assignment setting register SRD.

The CPU 20a refers to the assignment register RD according to the second command communication information and indirectly refers to the value register of each general-purpose terminal P by executing the above-mentioned initial setting.

As described above, the controller 20 of the present embodiment includes the CPU 20a and the ASIC 20b. The ASIC 20b has a plurality of the general-purpose terminals P. The ASIC 20b includes the value register, the assignment register RD, and the assignment setting register SRD. The value register stores information indicating the state of the general-purpose terminal P. The assignment register RD stores the value of the register indicated by the address based on the assigned address. Based on the connection of the general-purpose terminal P, the assignment setting register SRD stores the addresses of at least a part of the value registers among the value registers as the addresses to be stored of the assignment register RD. The assignment setting register SRD assigns the addresses of the value registers adjacently to the address of the assignment register RD1 and the addresses subsequent to the address.

As a result, the controller 20 of the present embodiment can acquire the state of the optional device through communication with less amount of information by referring to the assignment register RD.

The controller 20 of the present embodiment assigns the value register of the general-purpose terminal P whose function is enabled among the general-purpose terminals P to the assignment register RD. As a result, the controller 20 of the present embodiment can acquire the state of the optional device if the optional device is connected to the general-purpose terminal P. In this case, the CPU 20a may read only the value of the assignment register RD to which the register is assigned by the second command communication information. For example, the value register of the general-purpose terminal P is not assigned to the assignment register RD3 in some cases. In this case, the CPU 20a may execute the “read” command and receive the second command communication information which acquires only the assignment register RD1 and the assignment register RD2. The controller 20 of the present embodiment executes confirmation of only optional devices with high confirmation frequency. Thus, the controller 20 of the present embodiment can efficiently acquire the state of the optional device.

In the above description, a case in which the value register of the general-purpose terminal Pa is assigned to the assignment register RD1 is described, but the present invention is not limited to this. The CPU 20a may assign the value register of the general-purpose terminal P to which the optional device with high confirmation frequency is connected to the assignment register RD of the address with the higher order. In this case, the CPU 20a may execute the “read” command for acquiring the second command communication information and the “read” command for acquiring the first command communication information. In this case, the second command communication information includes the values of the assignment registers RD1 to RD3. The first command communication information includes the value of the assignment register RD1. Herein, the CPU 20a executes the “read” command for acquiring the first command communication information more frequently than the “read” command for acquiring the second command communication information. The controller 20 of the present embodiment executes confirmation of the optional device with higher confirmation frequency at a higher frequency and confirms an optional device with lower confirmation frequency at a lower frequency. As a result, the controller 20 of the present embodiment can efficiently acquire the state of the optional device.

The CPU 20a may assign the value register of the general-purpose terminal P to which the optional device with lower confirmation frequency is connected to the assignment register RD of the address with the lower order. In this case, the CPU 20a may execute the “read” command for acquiring the second command communication information and the “read” command for acquiring the first command communication information. In this case, the second command communication information includes the values of the assignment registers RD1 to RD3. The first command communication information includes values other than the assignment register RD3. Herein, the CPU 20a executes the “read” command for acquiring the first command communication information more frequently than the “read” command for acquiring the second command communication information. The controller 20 of the present embodiment confirms the optional device with the higher confirmation frequency at the higher frequency. As a result, the controller 20 of the present embodiment can efficiently acquire the state of the optional device.

In the above description, a case in which the value register of the general-purpose terminal P whose function is enabled is assigned to the assignment register RD is described, but the present invention is not limited to this. The CPU 20a may assign the value register of the general-purpose terminal P whose function is disabled to the assignment register RD. For example, the CPU 20a may assign the value register of the general-purpose terminal P whose function is disabled to the assignment register RD3. In this case, the CPU 20a executes the “read” command for acquiring the second command communication information and the “read” command for acquiring the first command communication information. The second command communication information includes the values of the assignment registers RD1 to RD3. The controller 20 of the present embodiment confirms the state of the general-purpose terminal P requiring no confirmation at a low frequency. Thus, the controller 20 of the present embodiment can efficiently acquire the state of the optional device.

In the above description, a case in which the ASIC 20b includes three general-purpose terminals P including the general-purpose terminal Pa to the general-purpose terminal Pc is described, but the present invention is not limited thereto. The ASIC 20b may include two general-purpose terminals P, or more than three general-purpose terminals P.

In the above description, a case in which the ASIC 20b has three assignment registers RD including the assignment registers RD1 to RD3 is described, but the present invention is not limited to this. The ASIC 20b may have two assignment registers RD, or more than three assignment registers RD.

In the above description, a case in which the value register of the general-purpose terminal P is assigned to the assignment register RD based on whether or not the optional device is connected to the general-purpose terminal P is described, but the present invention is not limited to this. For example, the value register of the general-purpose terminal P may be assigned to the assignment register RD according to the arrangement of patterns on the substrate on which the ASIC 20b is mounted. Herein, the function of the general-purpose terminal P of the ASIC 20b may be set based on the arrangement of patterns on the substrate on which the ASIC 20b is mounted. The function set in the general-purpose terminal P contains a function of a timer or the like in addition to the functions as the input terminal and the output terminal described above. For example, on a certain substrate, the ASIC 20b may set the general-purpose terminal Pa as a timer output, and on another substrate, set the general-purpose terminal Pa as the output terminal. In this case, the controller 20 of the present embodiment assigns the value register of the general-purpose terminal P to the assignment register RD according to the setting of the ASIC 20b. Thus, the controller 20 of the present embodiment can confirm the state of the value register of the general-purpose terminal P required to periodically confirm the state thereof by referring to the assignment register RD. In other words, the controller 20 of the present embodiment can shorten the time required to refer to the state of the value register of the general-purpose terminal P required to periodically confirm the state thereof. Therefore, the controller 20 of the present embodiment can efficiently grasp the state of the value register of the general-purpose terminal P required to periodically confirm the state thereof.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. An integrated circuit, comprising:
a plurality of general-purpose terminals;
a first register configured to store a plurality of values each indicating a state of each corresponding general-purpose terminal;
a second register configured to store a value of a register indicated by an address based on an assigned address; and
an assignment section configured to assign addresses in at least apart of the first register as addresses to be stored in the second register adjacent to a predetermined address in the second register and addresses subsequent to the predetermined address based on connection with any of the general-purpose terminals.

2. The integrated circuit according to claim 1, wherein
each of the general-purpose terminals enables or disables a corresponding function thereof at a time of an initial operation, and
the assignment section assigns an address in the first register corresponding to each of the general-purpose terminals as an address to be stored in a case in which the function of any of the general-purpose terminals are enabled.

3. The integrated circuit according to claim 2, wherein
the assignment section assigns the address in the first register as an address to be stored based on a reading frequency or a writing frequency of the first register.

4. The integrated circuit according to claim 3, wherein
the assignment section assigns the address of the first register with a high frequency to an address with a higher order in the second register as the address to be stored.

5. The integrated circuit according to claim 3, wherein
the assignment section assigns the address of the first register with a low frequency to an address with a lower order in the second register as the address to be stored.

6. The integrated circuit according to claim 2, wherein
the assignment section assigns the address of the first register corresponding to each of the general-purpose terminals to the address with the lower order in the second register in a case in which the function of any of the general-purpose terminals are disabled.

7. An image forming apparatus, comprising:
a plurality of general-purpose terminals;
a first register configured to store a plurality of values each indicating a state of each corresponding general-purpose terminal;
a second register configured to store a value of a register indicated by an address based on an assigned address; and
an assignment section configured to assign addresses of at least apart of the first register as addresses to be stored in the second register adjacent to a predetermined address in the second register and addresses subsequent to the predetermined address based on connection with any of the general-purpose terminals, wherein
at least one of an external device for executing an image forming processing of forming an image on an image receiving medium, an external device for executing an image reading processing of reading an object, and an external device for executing a post-processing on the image receiving medium on which the image is formed is connected to the general-purpose terminals.

8. The image forming apparatus according to claim 7, wherein
the assignment section assigns addresses of the first register corresponding to any of the general-purpose terminals to which the external device is connected among the first registers as addresses to be stored in the second register adjacent to a predetermined address in the second register and addresses subsequent to the predetermined address.

9. The image forming apparatus according to claim 8, wherein
the external device is at least one of a sheet feed apparatus, a sheet housing apparatus, an image reading apparatus, and a post-processing apparatus.

10. The image forming apparatus according to claim 8, comprising
at least two external devices selected from a sheet feed apparatus, a sheet housing apparatus, an image reading apparatus, and a post-processing apparatus.

11. The image forming apparatus according to claim 9, wherein
each of the general-purpose terminals enables or disables a corresponding function thereof at a time of an initial operation, and
the assignment section assigns an address in the first register corresponding to each of the general-purpose terminals as an address to be stored in a case in which the function of any of the general-purpose terminals are enabled.

12. The image forming apparatus according to claim 11, wherein
the assignment section assigns the address in the first register as an address to be stored based on a reading frequency or a writing frequency of the first register.

13. The image forming apparatus according to claim 11, wherein
the assignment section assigns the address of the first register corresponding to each of the general-purpose terminals to the address with the lower order in the second register in a case in which the function of any of the general-purpose terminals are disabled.

14. An address assignment method by an integrated circuit comprising a general-purpose terminal, a first register for storing a value indicating a state of the general-purpose terminal, and a second register for storing a value of a register indicated by an address based on the assigned address, comprising:
assigning addresses of at least a part of the first register as addresses to be stored in the second register adjacent to a predetermined address in the second register and addresses subsequent to the predetermined address based on connection with the general-purpose terminal.

15. The address assignment method according to claim 14, further comprising:
enabling or disabling a corresponding function thereof at a time of an initial operation, and
assigning an address in the first register corresponding to the general-purpose terminal as an address to be stored in a case in which the function of the general-purpose terminal is enabled.

16. The address assignment method according to claim 15, further comprising:
assigning the address in the first register as an address to be stored based on a reading frequency or a writing frequency of the first register.

17. The address assignment method according to claim 16, further comprising:
assigning the address of the first register with a high frequency to an address with a higher order in the second register as the address to be stored.

18. The address assignment method according to claim 16, further comprising:
assigning the address of the first register with a low frequency to an address with a lower order in the second register as the address to be stored.

19. The address assignment method according to claim 15, further comprising:
assigning the address of the first register corresponding to the general-purpose terminal to the address with the lower order in the second register in a case in which the function of the general-purpose terminal is disabled.

20. The address assignment method according to claim 14, further comprising at least one of:
executing an image forming processing of forming an image on an image receiving medium;
executing an image reading processing of reading an object; or
executing a post-processing on the image receiving medium on which the image is formed.
